(19) United States
(12) Patent Application Publication
(10) Pub. No.: US 2007/0119028 A1
(43) Pub. Date: May 31, 2007

(54) Folding mobile phone

(76) Inventors: Ching Chang Wang, Tucheng City (TW); Chih Yu Chen, Tucheng City (TW); Shao Guang Fang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/436,581

(22) Filed: May 19, 2006

(30) Foreign Application Priority Data
Nov. 25, 2005 (TW) 094220527

(51) Int. Cl. E05D 3/10

(52) U.S. Cl. 16/367; 16/303; 128/206.19

(57) ABSTRACT

A folding mobile phone with positioning mechanism includes a flip cover, a body, and a swivel hinge rotationally coupling the flip cover and the body about a first axis for unfolding the flip cover and a second axis perpendicular to the first axis for rotating the flip cover. The flip cover defines a positioning hole. The swivel hinge defines a chamber corresponding to the positioning hole. The positioning mechanism includes a resiliently biasing means contained in the chamber and a protrusion with one end thereof contacting the biasing means and the other end thereof extending out of the chamber. The biasing means resiliently biases the protrusion so that the protrusion is depressible within the chamber to enable the protrusion to be inserted into the positioning hole for positioning the flip cover or to be released from the positioning hole for permitting the flip cover rotation.

### BACKGROUND OF THE INVENTION

1. Field of the Invention

The invention relates to a folding mobile phone having a body and a flip cover rotationally coupled to the body about two perpendicular axes, and more particularly to a folding mobile phone further having a positioning mechanism to position the flip cover.

2. The Related Art

Mobile phones are increasingly utilized to permit a user to communicate telephonically over a wireless system at virtually any location. The mobile phone transmits a low wattage, radio frequency signal to a receiving station, which may be connected with conventional landline telephone systems.

Mobile phones utilizing two housing elements connected with some type of hinging mechanism are common. This folding arrangement allows for the mobile phone to be more compact when the two housings are foldable upon themselves. Mobile phones that utilize this type of design usually have most or all of the electronics within the larger of the two housings, hereinafter called a body. The smaller housing usually having a liquid crystal display on its inner side will hereinafter be called a flip cover.

Recently, a mobile phone having a camera for image communication has been developed. In such mobile phone, the camera is embedded in the body or the flip cover, or detachably mounted at the hinging mechanism. In order to take pictures in all directions, the camera together with the body or the flip cover or the hinging mechanism in which the camera is embedded should be able to be turned to all directions while ensuring the display always faces the user to enable the user to identify whether images has been taken in the display. Under such requirement, a mobile phone, of which the flip cover can perform rotating operation besides unfolding or opening and closing operation relative to the body, has been developed. However, there is a problem in that when the flip cover is unfolded, the flip cover maybe unintentionally rotates to an undesired direction.

### SUMMARY OF THE INVENTION

An object of the present invention is to provide a folding mobile phone having a positioning mechanism which is capable of positioning a flip cover of the mobile phone when the flip cover should not rotate in an unfolded position and release the flip cover when to intentionally rotate the flip cover, thereby preventing unintentional rotation of the flip cover.

In order to fulfill the above object, the present invention provides a folding mobile phone comprising a flip cover, a body, a swivel hinge, and a positioning mechanism. The flip cover has a bottom surface. A positioning hole is defined in the bottom surface. The swivel hinge rotationally couples the flip cover and the body about a first axis for unfolding the flip cover and a second axis perpendicular to the first axis for rotating the flip cover. The swivel hinge has a top surface. A chamber is defined in the top surface of the swivel hinge corresponding to the positioning hole. The positioning mechanism includes a resiliently biasing means contained in the chamber and a protrusion with one end thereof contacting the biasing means and the other end thereof extending out of the chamber. The biasing means resiliently biases the protrusion so that the protrusion is depressible within the chamber to enable the protrusion to be inserted into the positioning hole for positioning the flip cover or release from the positioning hole for permitting the flip cover rotation.

When the flip cover is desired to be kept in unfolded positions without rotation, the protrusion is inserted into the positioning hole of the flip cover to prevent the flip cover from rotating. While the flip cover rotates, the protrusion is depressed by the cover and then released from the positioning hole to permit the flip cover rotation. Therefore, unintentional rotation of the flip cover is avoided.

### BRIEF DESCRIPTION OF THE DRAWINGS

The present invention will be apparent to those skilled in the art by reading the following description of embodiments thereof, with reference to the attached drawings, in which:

FIG. 1 is a perspective view of a folding mobile phone according to the present invention, in which a flip cover of the folding mobile phone is in an unfolded position;

FIG. 2 is a perspective view of a swivel hinge of the folding mobile phone shown in FIG. 1;

FIG. 3 is a cross-sectional view along a line III-III of the swivel hinge shown in FIG. 2;

FIG. 4 is an exploded view showing a first embodiment of a positioning mechanism of the folding mobile phone to be mounted between the flip cover and the swivel hinge;

FIG. 5 is a cross-sectional view showing the positioning mechanism of the first embodiment mounted in the swivel hinge;

FIG. 6 is a perspective view of the folding mobile phone showing the rotation of the flip cover;

FIG. 7 is an exploded view showing a second embodiment of the positioning mechanism of the folding mobile phone to be mounted between the flip cover and the swivel hinge;

FIG. 8 is a cross-sectional view showing the positioning mechanism of the second embodiment mounted in the swivel hinge;

FIG. 9 is an exploded view showing a third embodiment of the positioning mechanism to be mounted between the flip cover and the swivel hinge; and

FIG. 10 is a cross-sectional view showing the positioning mechanism of the third embodiment mounted in the swivel hinge.

### DETAILED DESCRIPTION OF THE PREFERRED EMBODIMENTS

For facilitating understanding, like components are designated by like reference numerals throughout the various embodiments of the invention as shown in the attached drawings.

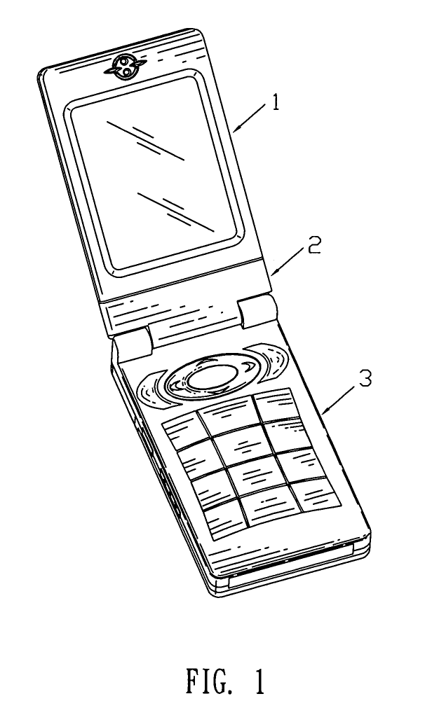

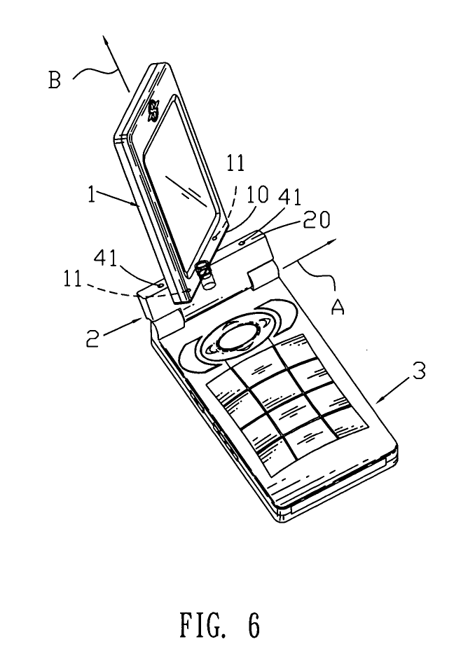

With reference to FIGS. 1-6, a first embodiment of a folding mobile phone according to the present invention is shown. The folding mobile phone has a flip cover 1, a swivel hinge 2, a body 3, and a portioning mechanism 4. The swivel hinge 2 rotationally couples the flip cover 1 and the body 3 about a first axis A for unfolding the flip cover 1 as seen in FIG. 1 and a second axis B perpendicular to the first axis A for rotating the flip cover 1 as seen in FIG. 6. Since the rotation structure and rotation function of the swivel hinge 2 are well known to those skilled in the art, a detailed description thereof is omitted herein except new structures designed in the present invention as described hereinafter. The positioning mechanism 4 is mounted between the flip cover 1 and the swivel hinge 2 for positioning the flip cover 1 in unfolded positions without rotation (as shown in FIG. 1) as will be described in greater detail hereinafter.

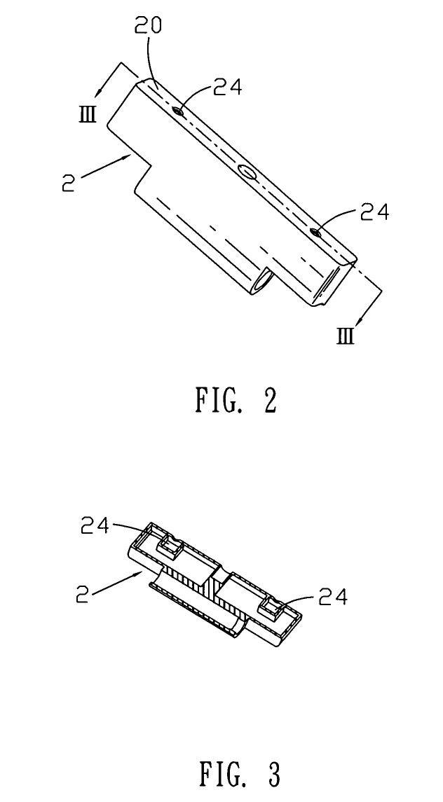

Referring to FIGS. 2 and 3, the swivel hinge 2 has a top surface 20. A pair of chambers 24 are disposed in the swivel hinge 2 at two opposite ends and open to the top surface 20.

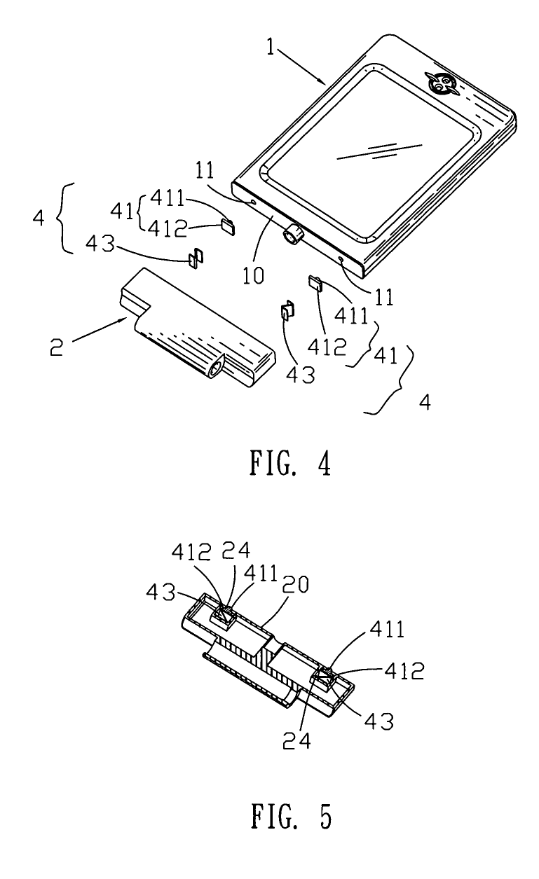

With reference to FIG. 4 and FIG. 5, the flip cover 1 and the positioning mechanism 4 are shown. The flip cover 1 has a bottom surface 10. A pair of positioning holes 11 are defined in the bottom surface 10 corresponding to the chamber 24 of the swivel hinge 2. The positioning mechanism 4 includes a protrusion 41 and a resiliently biasing means 43. In the first embodiment, the top end of the protrusion 41 forms an arced salient 411, and the bottom end of the protrusion 41 forms a flat base 412. The resiliently biasing means 43 is shaped in Z.

With reference to FIG. 5 again, the protrusion 41 and the resiliently biasing means 43 are all contained in the chamber 24. The flat base 412 of the protrusion 41 contacts the resiliently biasing means 43, and the arced salient 411 of the protrusion 41 extends out of the chamber 24 and over the top surface 20. The resiliently biasing means 43 props against the flat base 412 and resiliently biases the protrusion 41 so that the protrusion 41 is depressible within the chamber 24.

FIGS. 1 and 6 are perspective views of the flip cover 1 and the body 3. Prior to assembly of the flip cover 1 and the body 3, the positioning mechanism 4 is disposed into the swivel hinge 2 as described above. Thereafter, the bottom side of the swivel hinge 2 connects the body 2 and the opposite top side of the swivel hinge 2 connects the flip cover 1. After the flip cover 1 is assembled to the swivel hinge 2, the flip cover 1 is rotatable about axis B. During the rotation, the protrusion 41 is pressed downward by the bottom surface 10 of the flip cover 1 until it is approximately flush with the top surface 20 of the swivel hinge 2. Then the protrusion 41 is maintained depressed and the resiliently biasing means 43 exerts a compression force on the flat base 412 of the protrusion 41. Once the protrusion 41 is aligned with the positioning hole 11, a resilient force of the biasing means 43 urges the arced salient 411 of the protrusion 41 to be inserted into the positioning hole 11 of the flip cover 1. Thus the flip cover 1 is positioned and can be kept in unfolded positions without rotation. Unintentional rotation of the flip cover 1 is avoided. When the flip cover 1 is desired to be rotated, manually rotates the flip cover 1 and the protrusion 41 is depressed within the chamber 24 again. The arced salient 411 is released from the positioning hole 11. So the flip cover 1 is allowed to rotate.

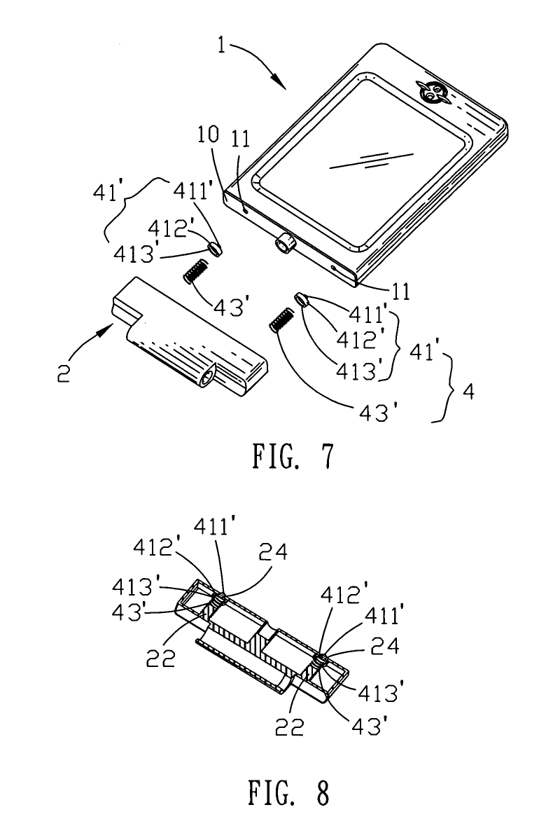

With reference to FIG. 7 and FIG. 8, a second embodiment of the folding mobile phone is shown. The folding mobile phone in the present embodiment is similar to that shown in the first embodiment. The difference between the first embodiment and the second embodiment is only in the positioning mechanism 4. The positioning mechanism 4 includes a protrusion 41′ and a resiliently biasing means 43′. The top end of the protrusion 41′ forms an arced salient 411′, and the bottom end of the protrusion 41′ forms a cap 412′ with a fringe 414 there-around. The resiliently biasing means 43′ is a helix spring. The cap 412′ is put on the helix spring 43′ to make the protrusion 41′ reliably contact the helix spring 43′ and combines with the helix spring 43′ by the fringe 413′ of the cap 412′. The fringe 413′ of the cap 412′ stops the helix spring 43′ sliding and makes the protrusion 41′ to be firmly combined with the helix spring 43′. Preferably, the swivel hinge 2 further forms a cylindrical pole 22 in chamber 24 in the second embodiment, and a bottom end of the helix spring 43′ is disposed on the cylindrical pole 22.

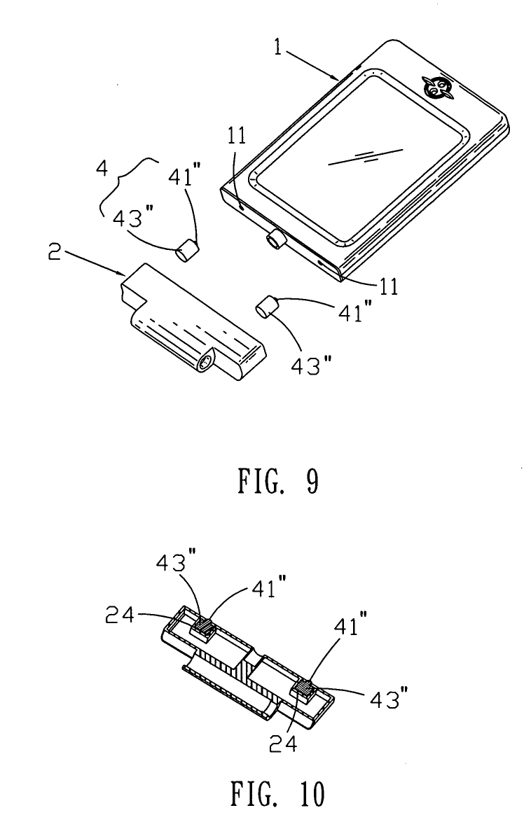

With reference to FIG. 9 and FIG. 10, a third embodiment is shown. The difference between the first embodiment and the third embodiment is also only in the positioning mechanism 4. The positioning mechanism 4 has a resiliently biasing means 43″ and a protrusion 41″. The resiliently biasing means 43″ and the protrusion 41″ are fabricated of a unitarily molded single component of rubber. The resiliently biasing means 43″ is inserted into the chamber 24 and can be deformed similar to the first embodiment, and the protrusion 41″ extends out of the chamber 24.

While the present invention has been described with reference to special embodiments, therefore the description is illustration and is not to be constructed as limiting the invention, Various modifications to the present invention may be made to the preferred embodiments by those skilled in art without departing from the true spirit or scope of the invention as defined by the appended claim.

What is claimed is:

1. A folding mobile phone comprising:
a flip cover having a bottom surface, a positioning hole being defined in the bottom surface;
a body;
a swivel hinge rotationally coupling the flip cover and the body about a first axis for unfolding the flip cover and a second axis perpendicular to the first axis for rotating the flip cover, the swivel hinge having a top surface, a chamber being defined in the swivel hinge and opening to the top surface corresponding to the positioning hole; and
a positioning mechanism comprising a resiliently biasing means contained in the chamber and a protrusion with one end thereof contacting the biasing means and the other end thereof extending out of the chamber, the biasing means resiliently biasing the protrusion so that the protrusion is depressible within the chamber to enable the protrusion to releasably insert into the positioning hole.

2. The folding mobile phone as claimed in claim 1, wherein the resiliently biasing means is Z-shaped.

3. The folding mobile phone as claimed in claim 1, wherein the resiliently biasing means is a helix spring.

4. The folding mobile phone as claimed in claim 3, wherein the swivel hinge further forms a cylindrical pole in the chamber, the helix spring is disposed on the cylindrical pole.

5. The folding mobile phone as claimed in claim 1, wherein the protrusion has an arced salient and a flat base, and the resiliently biasing means props against the flat base.

6. The folding mobile phone as claimed in claim 1, wherein the protrusion has an arced salient and a cap, and the cap is put on the resiliently biasing means to make the protrusion reliably contact the resiliently biasing means.

7. The folding mobile phone as claimed in claim 1, wherein the resiliently biasing means and the protrusion are fabricated of a unitarily molded single component of rubber.
